(19) United States
(12) Patent Application Publication
(10) Pub. No.: US 2013/0013492 A1
(43) Pub. Date: Jan. 10, 2013

(54) METHOD AND SYSTEM FOR REFUNDS AND/OR CREDITS RESPONSIVE TO CONSUMER DISSATISFACTION WITH SOFTWARE DOWNLOADS

(76) Inventor: Chris R. Nelson, Mantoloking, NJ (US)

(21) Appl. No.: 13/473,198

(22) Filed: May 16, 2012

Related U.S. Application Data
(60) Provisional application No. 61/486,847, filed on May 17, 2011.

(51) Int. Cl. G06Q 20/22

(52) U.S. Cl. 705/39

(57) ABSTRACT

A method for providing buyer protection for purchased software includes receiving input, from an input device, to initialize buyer protection applicable to purchased software and providing the purchased software to the input device. The method also includes processing payment, by a processor, of a fee for a return of the purchased software, determining that a request for return of purchased software has been received from the input device, and approving the return of the purchased software. By the processor, the method also encompasses steps of at least one of returning, as a refund, at least a portion of a price paid for the purchased software or providing a credit against a future software purchase and at least one of disabling or removing the purchased software from the input device.

### CROSS-REFERENCE TO RELATED APPLICATION(S)

This Non-Provisional United States Patent Application relies for priority on U.S. Provisional Patent Application Ser. No. 61/486,847, filed on May 17, 2011, the content of which is incorporated herein by reference.

### FIELD OF THE INVENTION

The present invention concerns a method and system whereby a consumer may receive a refund and/or a credit if the consumer is dissatisfied with the purchase of software over a wide area network, such as the Internet. More specifically, in one contemplated embodiment, the present invention concerns a method and system whereby a consumer may receive a refund/credit if dissatisfied with the purchase of a type of software commonly referred to as an “app.”

### BACKGROUND OF THE INVENTION

As should be apparent to consumers, mobile computing devices have become increasingly popular.

Specifically, smartphones and tablet devices (hereinafter “smart devices”) have proliferated many aspects of everyday life. Many of these smart devices permit the downloading of software designed for one use or another.

Perhaps the most well-known examples of smart devices are the iPhone® and iPad®, which are products of Apple, Inc. of Cupertino, Calif.

Regardless of the type of product or its manufacturer, a significant market has developed for the creation and sale of apps that are executable on these smart devices.

It has been reported that, in January 2011, there were more than 350,000 apps registered with the iTunes® Store and more than 10 billion apps had been downloaded from the iTunes® Store. In December 2011, a web monitoring group reported that there were a total of one (1) million apps on the Internet, This number included apps from the iTunes® Store and Google's Android® platform.

As should be apparent to the app consumer, the average price paid for apps is estimated to be between $3.50 and $4.00 (USD).

While less commonly appreciated by the app purchaser, it has been reported that developers of the apps that are sold may receive up to 70% of the proceeds from the sale of the apps on-line (i.e., over the Internet). Moreover, since apps are typically distributed from a common marketplace, there are few costs associated with the distribution of the app.

As also should be apparent to app consumers, the purchase and download of a selected app is an automated process. There are no persons involved in the transaction (other than the purchaser, of course). Moreover, the sale is considered to be final.

Not only is the sale of an app final, but it is also non-refundable. When a consumer purchases an app, if the consumer is unhappy with the app, there is no mechanism through which the app may be returned for a refund and/or a credit to the app consumer.

There are examples in the prior art of methods for the return of products purchased on-line (i.e., via the Internet).

U.S. Patent Application Publication No. 2003/0135421 (hereinafter “the '421 Application”) describes a buyer protection service. Specifically, the '421 Application concerns a method to refund the buyer purchase price of a product that is not received or determined by the buyer to be unacceptable upon receipt. (The '421 Application at paragraph [0004].) The buyer protection service is a third party service. (The '421 Application at paragraph [0014].) Upon purchase of the software, the buyer pays a flat fee or a fee based on the price of the software product. (The '421 Application at paragraph [0037].) Since the buyer has paid for the protection service, the buyer has undisputed authority to accept or reject the product after being received by mail. (The '421 Application at paragraph [0038].)

U.S. Patent Application Publication No. 2003/0126033 (hereinafter “the '033 Application”) describes a system, method, and article of manufacture for software source authentication for return purposes. Specifically, the '033 Application permits a return of digital products that are distributed electronically. (The '033 Application at paragraph [0146].) The refund is processed based on a proof of purchase that is received over the network, which prevents fraud with respect to the refund. (The '033 Application at paragraph [0147].)

U.S. Patent Application Publication No. 2001/0047315 (hereinafter “the '315 Application”) describes a system and method for single-action returns of remotely purchased merchandise. The system provides for processing whereby a buyer may return a purchased item via a single action, such as a single click of a mouse. After initiating the return, basic information regarding the return is exchanged electronically, including the scheduling of a pick-up time for the product. (The '315 Application at paragraph [0052].)

U.S. Pat. No. 8,126,778 (hereinafter “the '778 Patent”) describes a network reputation and payment service. After a buyer purchases a digital item, the buyer may request a refund, which refund triggers an update in the parties “reputations.” (The '778 Patent at col. 5, lines 13-22.) The “reputation” of the buyer is a factor that is taken into account with respect to whether or not the buyer is entitled to the refund. (The '778 Patent at col. 5, lines 22-28.)

U.S. Pat. No. 7,890,373 (hereinafter “the '373 Patent”) describes a method and apparatus for verifying product sale transactions and processing product returns. Specifically, the '373 Patent addresses returns of items while avoiding fraud. (The '373 Patent at col. 3, lines 18-26.) For example, the serial number of the product, among other information associated with the transaction, may be used to validate the propriety of the return. (The '373 Patent at col. 5, lines 58-65.)

While the prior art identifies different aspects of product return, whether the return is for a digital product or a physical product, the prior art provides little guidance for the return of software, including apps.

### SUMMARY OF THE INVENTION

The present invention provides an automated system and method that may be employed so that a user may obtain a refund/credit if dissatisfied with the purchase of software, such as an app, via a wide area network, such as the Internet.

As a preliminary matter, while the present invention is described in connection with apps specifically, the present invention is understood to apply to any type of software and is not limited solely to apps.

In one contemplated aspect, the present invention provides a buyer with the ability to purchase “insurance” that permits the buyer to return an app.

The buyer may be permitted to return the app because the buyer is dissatisfied with the quality or performance of the app product.

Alternatively, the buyer also may be permitted to return the app for any reason, including if the buyer subsequently experiences “buyer remorse” and wants to return the software without any supporting justification.

The present invention also contemplates that the “insurance” purchased by the buyer may be employed to monitor the quality of the apps offered for sale by a software developer (or seller). For example, if the developer has a high number of returns, the developer may no longer be permitted to present the frequently-rejected app for sale. Alternatively, if the developer establishes a history of apps that are returned, the developer may be barred for offering further apps for sale in the software marketplace.

As should be apparent, the ability to monitor the quality of apps offered for sale by a developer also provides a way to incentivize developers to offer higher quality products. It is, therefore, one aspect of the present invention to provide feedback to developers based on the number of returns so that the developer may improve the quality of apps that the developer provides to consumers.

It is one aspect of the present invention to provide a method for providing buyer protection for purchased software. The method includes receiving input, from an input device, to initialize buyer protection applicable to purchased software and providing the purchased software to the input device. The method further includes processing payment, by a processor, of a fee for a return of the purchased software and determining that a request for return of purchased software has been received from the input device. By the processor, the method includes steps of approving the return of the purchased software and at least one of returning, as a refund, at least a portion of a price paid for the purchased software or providing a credit against a future software purchase. Finally, the method includes at least one of disabling or removing the purchased software from the input device.

In one contemplated embodiment of the present invention, the input device includes the processor.

In another contemplated embodiment, the fee is valid for the return of purchased software during a predetermined period of time.

In a further embodiment of the present invention, the fee is valid for a plurality of returns of purchased software during a predetermined period of time.

An additional embodiment of the present invention contemplated that the refund decreases proportionately with an increased elapsed time from a time of purchase.

Still further, the refund may be proportionate to the price paid for the purchased software.

In another embodiment of the present invention, the method includes associating the buyer protection with the purchased software.

It is also contemplated that the method may include requesting at least one reason for the return of the purchased software.

If so, the method may also include receiving input explaining the at least one reason for the return of the purchased software.

Where input is received concerning the reason for the return, the method may include determining if the at least one reason for the return of the purchased software satisfies at least one predetermined condition for approval of the return of the purchased software.

In one embodiment of the present invention, the method includes transmitting the fee for the return of the purchased software.

In another embodiment, the method includes reducing the price paid for the purchased software by the fee for the return of the purchased software.

In a further embodiment, the method includes informing a developer of the purchased software of the return of the purchased software.

Also, the method may include tracking a frequency of returns for the purchased software.

An alternative embodiment of the method of the present invention encompasses a method for providing buyer protection for purchased software where, from an input device, the method receives input to initialize buyer protection applicable to purchased software and provides the purchased software to the input device. By a processor, the method processes payment of a fee for a return of the purchased software, determines that a request for return of purchased software has not been received from the input device, and transmits at least one incentive for non-receipt of the return of the purchased software.

In this alternative embodiment, the incentive may include at least a portion of the fee for the return of the purchased software.

Alternatively, the incentive may include the fee for the return of the purchased software.

In a further alternative embodiment, the incentive may include a credit applicable against a future purchase of software.

It is contemplated that the at least one incentive includes at least a portion of or the price paid for the purchased software.

Still further aspects of the present invention will be made apparent from the discussion that follows.

### BRIEF DESCRIPTION OF THE DRAWING(S)

FIG. 1 is a graphical illustration of a system according to the present invention;

FIG. 2 is a graphical overview of a first portion of a method contemplated by the present invention;

FIG. 3 is a graphical overview of a second portion of a method contemplated by the present invention, this second portion being a continuation of the first portion illustrated in FIG. 2; and

FIG. 4 is a graphical overview of a third portion of a method contemplated by the present invention, this third portion being a continuation of the second portion illustrated in FIG. 3.

### DETAILED DESCRIPTION OF EMBODIMENT(S) OF THE INVENTION

The present invention will now be described in connection with one or more contemplated embodiments. Focus on any one particular embodiment in the discussion that follows should not be understood to be limiting of the present invention. To the contrary, the description of one or more embodiments of the present invention is intended to be illustrative of the breadth and scope of the present invention.

The present invention is contemplated to be employed by a software provider or the provider of a marketplace for the sale of software. Specifically, the present invention is contemplated to be provided, as an enhancement, to sales services provided by a software vending service in the context of a software marketplace. One well-known marketplace is the iTunes® Store offered via the Internet by Apple, Inc. of Cupertino, Calif. Another well-known marketplace is affiliated with Google's Android® platform. Google, Inc. is headquartered in Mountain View, Calif.

While the present invention is contemplated to be employed in connection with an on-line software marketplace, the present invention should not be understood to be limited solely to such an environment. The present invention may be offered in other contexts without departing from the scope thereof. For example, the present invention may be offered in connection with the purchase of any type of computer software that is available for download via the Internet.

As discussed in greater detail in the paragraphs that follow, the software vending service (i.e., the software marketplace) is contemplated to encompass a software vendor that connects developers (i.e., sellers) to buyers so that the buyers may purchase software programs, such as apps, from the developers of the software. It is contemplated that the software vending service will provide the return/credit protection provided by the present invention. In the discussion that follows, the method of the present invention also is referred to as “insurance protection,” because it is contemplated that a buyer will purchase the ability to return software that the buyer determines to be unacceptable.

In one contemplated embodiment, the insurance protection is contemplated to be provided directly by the administrator and/or operator of the on-line software marketplace. For example, the iTunes® Store may provide the present invention as a supplemental service to its customers.

Alternatively, the insurance protection may be provided by a third party. In this example, services are contemplated to be made available to users independently of any particular on-line marketplace. It is contemplated that the insurance protection will be purchased by the third provider and then honored by the software marketplace from which the software is purchased.

Before delving into the details of the present invention, a brief overview is provided.

In one embodiment, it is contemplated that a buyer of software will purchase buyer protection (or insurance), which acts as a credit against a future purchase of software. Specifically, when a buyer elects to purchase the buyer protection, the buyer will receive one or more “credits,” which may be redeemed at a future date. The buyer uses or redeems that credit when selecting to return a particular software product. Alternatively, when a buyer returns an app, the buyer may receive a credit that permits the buyer to purchase another app, at a future date, for the same purchase price as the returned software.

For example, the software buyer may buy the protection package, in advance of a purchase, for a fixed fee (e.g., $50.00 USD per year) to protect up to a predetermined number of software (i.e., app purchases). In another contemplated embodiment, the buyer may purchase the insurance on a single use basis (e.g., buy app protection before a specific app is purchased). In either instance, the cost of the buyer protection may be determined by the purchase price of the app. For example, the cost of the buyer protection may be determined as a percentage of the purchase price of the cost of the app.

In one contemplated embodiment of the present invention, after purchasing the app, the consumer is unhappy with the software, the consumer who has purchased the buyer protection will be permitted to apply for a refund/credit within a certain number of days from the purchase of the app. Alternatively, the credit may be configured to permit a refund/credit of the app at any time after the purchase of the app.

In one aspect of the present invention, the consumer (also referred to as “the user”) that purchases the buyer protection may be queried to supply a reason for initiating the refund of the purchase price of the software. In such an instance, the refund/credit may be conditional upon an acceptable reason for the refund/credit. If the reason for the return meets the criteria of the buyer protection, the user's account would be credited or refunded.

In another aspect of the present invention, the insurance may not be conditioned upon receipt of any particular reason for the return. Such “fault-free” protection is contemplated to permit the user to receive a refund/credit in the absence of any suitable justification. Simply, the user may return the software product because the user does not like the purchased app.

In one contemplated embodiment, the method and system of the present invention keeps track of the number of requests for refund/credit that are made by consumers for individual apps. By monitoring performance of users, the system provides a way to evaluate the success of a particular app by monitoring the number and/or frequency of returns and/or credits.

It is contemplated, for example, that if an app exceeds a fixed level of returns, the software marketplace may be automatically notified so that the marketplace may decrease the share of the app's revenue to the developer to cover the refund/credit cost. Alternatively, for a particularly poor app, which has a high number of returns, the marketplace may elect to remove the app from the types of software that the marketplace sells. If the developer establishes a track record for apps that are returned on a regular basis, the developer may be barred from featuring apps in the particular marketplace.

In another contemplated embodiment, the method and system of the present invention is provided with functionality that tracks the reasons for the refunds and/or credits requested.

In this contemplated embodiment, once an app receives a predetermined number of the same reasons for return (i.e., the app causes the user's smart device to cease operating or the app fails to initialize), an alarm or notice may be provided to the operator of the marketplace so that the marketplace is able to determine if the app should be removed from the marketplace altogether. The reasons for return may be shared with the developer so that the developer may correct the error in the software and, thereby, reduce the incidence of future returns.

In still another contemplated embodiment of the invention, the seller of a smart device might purchase the buyer protection as an incentive to consumers to buy the smart device. For example, Apple® might purchase a predetermined number of app returns/credits and provide them to the purchaser of the smart device. As a result, the purchaser of the smart device would be able to return and/or receive credits for a predetermined number of apps as an incentive to try the on-line marketplace.

In still another contemplated structure for the buyer protection of the present invention, it is contemplated that, after a user purchases a predetermined number of credits (i.e., ten (10) returns), the next return is free. As should be apparent, in this contemplated embodiment, there are limitless variations on the basic concept.

As should be apparent from the foregoing, the developer's share of revenue from the sale of apps may be adjusted based on the number of times the developer's apps are returned. For example, if the app is returned to the marketplace more than 10% of the time, the developer's revenue might be decreased by 5%. If the app is returned more than 20% of the time, the developer's revenue may be decreased by 10%. If the app is returned more than 30% of the time, the developer's revenue might be decreased by 20%. When the app is returned more than 40% of the time, the developer's revenue may be decreased by 30%. If the app is returned more than 50% of the time, the app may be removed from the marketplace to prevent future sales of the app. Alternatively, the developer may be barred from selling apps through the marketplace in the future.

Consumers that like the apps that they purchase are anticipated to benefit from the present invention as much as those that dislike the purchased apps.

For example, if a user buys a predetermined number of returns/credits but chooses not to use any of them, the user may be provided with a selected number of additional returns/credits free of charge. In this contemplated embodiment, assume that a user has purchased ten (10) apps and buyer protection for each of those apps. Being satisfied with the apps, the user did not return any of them to the marketplace or request a credit against future purchases.

In this set of circumstances, the user has purchased the buyer protection, but has not availed himself or herself of the benefits of the buyer protection. So that the consumer does not feel that the purchase of buyer protection was without any benefit, the method of the present invention may be programmed to provide this user with additional returns/credits for free. For example, the next five returns/credits are free of charge in return for the user's failure to exercise any of the purchased credits.

In connection with the purchase of buyer protection, the present invention is configured to collect and distribute monies to the various participants (i.e., the various marketplaces) that provide the buyer protection program to consumers. The monies that are collected are contemplated to be provided to the marketplace on a periodic basis. For example, monies would be paid if a week has passed since the purchase of the buyer protection credit redeemed that refund/credit. In instances where the refund/credit is not redeemed, a similar timing may be employed. For example, the refund/credit may be recognized as being for a particular marketplace and be valid for a predetermined period of time, such as a week.

In instances where the user redeems a refund/credit, the money paid for the refund/credit (or some portion thereof) may be transferred to the marketplace, which may distribute those monies as dictated by the contractual arrangements associated with that marketplace. Alternatively, the monies may be kept by the marketplace as a part of the administrative costs associated with offering the buyer protection software of the present invention.

It is contemplated that, when a user redeems a refund/credit, the original purchase price will be returned in full to the user. Alternatively, the user may receive the original purchase price of the app minus the price of the insurance for the app. In this second instance, the user does not pay for the insurance until the credit is redeemed. In another contemplated embodiment, the user does not receive the purchase price. Instead, the user receives a credit, equal to the purchase price of the returned software, to be applied against a future purchase.

If a return is made to a user who has availed himself or herself of the buyer protection program, the method of the present invention may provide an alert to the developer of the returned software so that the developer is aware of the return. If there is a reason for the return, such as when the software app has a defect, the developer may then devote efforts to correct the error in the app to minimize future returns.

As should be apparent from the foregoing there are a number of benefits that result from the present invention. First, the user receives the benefit of being able to return apps to the marketplace, if dissatisfied with the app. This encourages users to download apps with confidence and with greater frequency, because the users are able to return apps when dissatisfied. Second, the marketplace receives feedback about the apps that it makes available to users. This makes it possible to remove apps from the marketplace that are returned a significant number of times. As a result, the marketplace is able to maintain an acceptable level of quality for its users. Third, the developer receives feedback from users, in the form of the reasons for the return of an app. This permits the developer to improve apps offered through the marketplace. The incentive for the developer is to improve the software product and to avoid the possibility of being removed from the marketplace if the number of returns exceeds the threshold number.

As should be apparent from the overview provided above, the present invention may be administered by a third-party by making the present invention available to marketplaces selling software such as apps. For example, a company such as PayPal® (a payment provider) or an insurance company may make the present invention available to users by offering the buyer protection plan. In this contemplated configuration, the third party assumes responsibility for administering the buyer protection and providing fees and monies to the marketplaces where users have requested one or more refunds.

As also should be apparent from the foregoing discussion, the architecture of the present invention is contemplated to be provided in parallel with functionality permitting a consumer to purchase and download specific programs, commonly referred to as apps. As should be apparent to those skilled in the art, the present invention is anticipated to be accessible by a consumer accessing a particular website, via the Internet.

In the most common architecture, the consumer is understood to access the Internet via a personal computer or similar electronic device (such as a smart phone, for example). The consumer would then connect to a server that hosts the app store (i.e., the software marketplace). The system is anticipated to encompass additional servers and hardware, as should be apparent to those skilled in the art.

The present invention may be available to the consumer via the website that permits the selection, purchase, and download of particular programs (i.e., the Apple® iTunes® Store and Google's Android® platform). Alternatively, the present invention might be purchasable by the consumer separately. In this case, the consumer would purchase the software and be permitted to apply the benefits of the software to any site visited by the consumer, assuming that the visited website is a participant in the refund/credit aspect of the present invention.

The present invention, therefore, presents a method that is implemented in software, which permits a consumer to request and receive a refund and/or credit, should the consumer be dissatisfied with a particular software purchase.

While a method is contemplated as one aspect of the present invention, it also should be understood that the present invention also encompasses a system through which the method is enacted. The present invention also encompasses a computer readable medium that incorporates instructions permitting the method to be executed.

It is noted that the concept of an App is not limited to programs such as those available through a traditional App Store. It is contemplated that the present invention also could be applied to the download of programs, software, music, movies, and other electronic content, whether downloaded or purchased in a traditional sense.

While the present invention is directed to electronic files that are purchased, either on line or via more traditional channels of trade, the present invention also may find applicability to other modes of commerce. Accordingly, while directed to electronic media and files, the present invention should not be understood to be limited solely thereto.

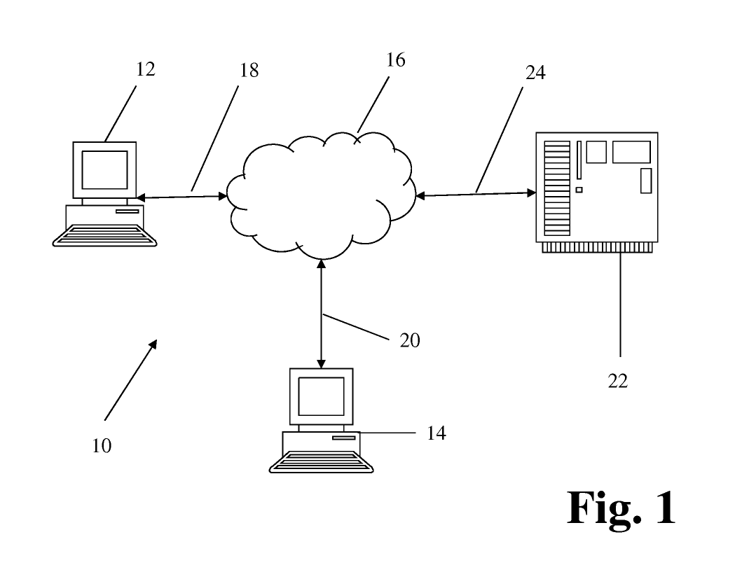

Reference is now made to FIG. 1, which provides a graphical illustration of one system contemplated by the present invention. The system architecture 10 encompasses two interface devices 12, 14, which may be smart devices, computers, or the like. The interface devices 12, 14 connect to a wide area network 16, such as the Internet, via two way communication links 18, 20. The wide area network 16, in turn, is connected to a marketplace server 22 via a two way communication link 24.

As illustrated in FIG. 1, the communication links 18, 20, 24 are contemplated to be two way links. Alternatively, the links 18, 20, 24 may be substituted by two or more one way links. The links 18, 20, 24 may permit wired or wireless communication between the various parts of the system 10.

With reference to the marketplace server 22, the marketplace server 22 is contemplated to store and run the executable code that implements the instructions associated with the method of the present invention. As should be apparent to those skilled in the art, the marketplace server 22 need not be the sole device that stores or executes the code of the present invention. It is contemplated that the method of the present invention may be executed across several devices, serially or in parallel.

In still another contemplated embodiment, the method of the present invention may be executed on one or more of the interface devices 12, 14. In this contemplated embodiment, the software that implements the method of the present invention may be an app that is downloaded onto the interface devices 12, 14. For example, it is contemplated that an app for buyer protection may be downloaded from the marketplace server 22, via the Internet 16, to a smart device 12, 14. The smart device 12, 14 would then execute the code associated with the method of the present invention.

As should be apparent to those skilled in the art, the method of the present invention may have shared operations between the interface device 12, 14, which is also an input device, and a processor, which is a part of the marketplace server. Other processors also may be involved in the performance of the method of the present invention, depending upon the system architecture employed. Naturally, the involvement of a third party is anticipated to increase the complexity of the system and method of the present invention.

Before turning to the method 26 of the present invention, it is noted that communication between the various components of the system architecture 10 are anticipated to be governed by any one of a variety of communication protocols. The exact manner of the communication is not critical for operation of the present invention, as should be apparent to those skilled in the art.

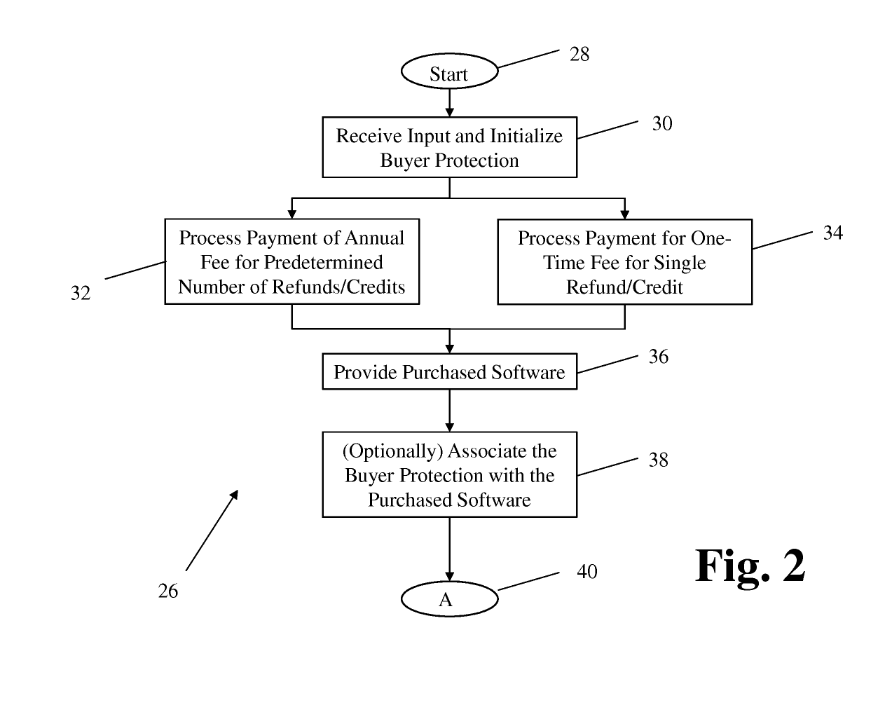

The buyer protection method 26 of the present invention is depicted in FIG. 2.

The method 26 begins at the start 28. The method 26 proceeds to step 30, where the buyer protection is initialized. The initialization of the buyer protection occurs in response to receipt of input from a buyer who is seeking to insure one or more purchases of software in advance of the purchase of that software (or app). Initialization of the buyer protection may occur when a buyer clicks on a link or downloads an app embodying the method 26 of the present invention. It is contemplated that initialization of the buyer protection may be made via the input device 12, 14. Of course, it is also contemplated that the buyer protection may be initialized via a separate computer or device without departing from the scope of the present invention.

It is contemplated that initialization of the buyer protection 28 will occur in different ways depending on the channels through with the buyer protection method 26 is offered.

For example, where the buyer protection method 26 is offered by the on-line marketplace, the buyer may simply indicate (via a click box) that he or she would like to insure a particular purchase. It is understood in this context that the user has already signed up for the services provided by the marketplace and, therefore, that additional information need not be provided as input to initialize the buyer protection service.

As should be apparent to those skilled in the art, where a buyer initializes the buyer protection method 26 of the present invention via a third party provider, the buyer is likely to be asked to setup an account and provide billing information, among other steps. Since the third party provider will interface with the marketplace, it is contemplated that it may be necessary to create an electronic identifier for the buyer at the third party provider.

The initialization step 28 is anticipated to be accompanied by a payment step, which may fall into one of at least two common varieties. The first payment type is expected to be an annual fee, the processing of which is designated by the reference number 32 in FIG. 2. The second payment type is contemplated to be the payment of a fee for insurance against the return of software in a single instance, the processing of which is embodied in step 34 in FIG. 2.

In the context of the annual fee as embodied by step 32, it is contemplated that the fee paid for an annual subscription to the buyer protection service will permit a user to return a preset number of apps during the course of the subscription. As should be apparent, there may be different price points set for different buyer programs. For example, an entry level annual fee of $14.99 (USD) may provide for ten (10) returns of apps during the year. An annual fee of $24.99 (USD) may be sufficient to purchase twenty (20) returns for the year. Perhaps a fee of $49.99 (USD) might be sufficient to permit an unlimited number of returns for the year. As should be apparent, the pricing provided above is merely exemplary. The provider of the buyer protection service of the present invention will set prices according to various market factors.

In the context of a single use fee as embodied in step 34, it is contemplated that the user will pay a fee to insure against dissatisfaction with the purchase of a single app. The fee may be set according to the price of the app for which insurance is being paid, as should be understood by those skilled in the art.

As should also be apparent, there are other pricing arrangements that may be established to satisfy the customers that visit a particular marketplace. The examples provided herein are intended to be exemplary of the large variety of pricing schedules that may be employed.

With respect to the payment steps 32, 34, it is contemplated that payment may be made at the time of that the buyer protection is initialized. Alternatively, payment may be made after certain conditions are met. Still further, payment may be made one a periodic basis (such as monthly). In the context of the present invention, the term “payment” should not be understood to be limited solely to an instantaneous payment of monies.

In connection with the payment steps 32, 34, the terms “refund” and “credit” are used.

A refund is understood to be a return of at least a portion of monies paid for a particular app. For example, the user pays $2.99 (USD) for an app. A refund is anticipated to encompass an amount up to $2.99 (USD), which is credited back to the user at the time of the qualifying return.

The term “credit” is intended to encompass instances where monies are not refunded. Instead, a credit is provided to the user, which may be applied against a future purchase of an app. For example, the user purchases an app for $2.99 (USD). Upon returning the app, the user does not receive the $2.99 (USD) paid for the app. Instead, the user receives a credit of $2.99 (USD) that may be deducted from the price of an app to be purchased at a future time.

In the context of the present invention, it is noted that the terms “refund” and “credit” may be used interchangeably. While defined above, the terms “refund” and “credit” should not be narrowly construed in the context of the present invention. They are intended to apply to a broad spectrum, as should be apparent from the discussion of the present invention.

After the payment steps 32, 34, the method 26 proceeds to step 36, where the method provides the purchased software to the user.

The method 26 then proceeds to step 38, where the method may optionally associate the buyer protection to the app that has been purchased based on input received from the user. Alternatively, the method 26 may associate the buyer protection to the purchased software based on other qualifying parameters, as should be apparent to those skilled in the art. At this step, it is contemplated that the method 26 will connect the buyer protection that has been purchased in one of steps 32, 34 with the app being purchased in step 38. Once the buyer protection is associated with the app, it is understood that the buyer protection cannot be disassociated from that app, at least in one embodiment of the present invention. Alternatively, a method is contemplated where the buyer protection may be decoupled from the purchased software, under predetermined circumstances.

The contextual background for step 38 is fairly straight-forward. Since a buyer cannot preview an app before its purchase, the buyer may not feel particularly confident about the purchase of an app prior to its purchase. If the buyer is motivated to insure the purchase against the possibility of a return, the buyer does so at the time (or before the time) that he or she completes the purchase of the app in step 38.

As noted in FIG. 2, step 38 is an optional step. As discussed above, it is contemplated that the method 26 of the present invention may be offered as part of an unlimited returns package. If so, every purchase made by a user is subject to return and/or credit. In this context, therefore, the user would not need to associate the buyer protection with a particular app prior to the purchase of the app.

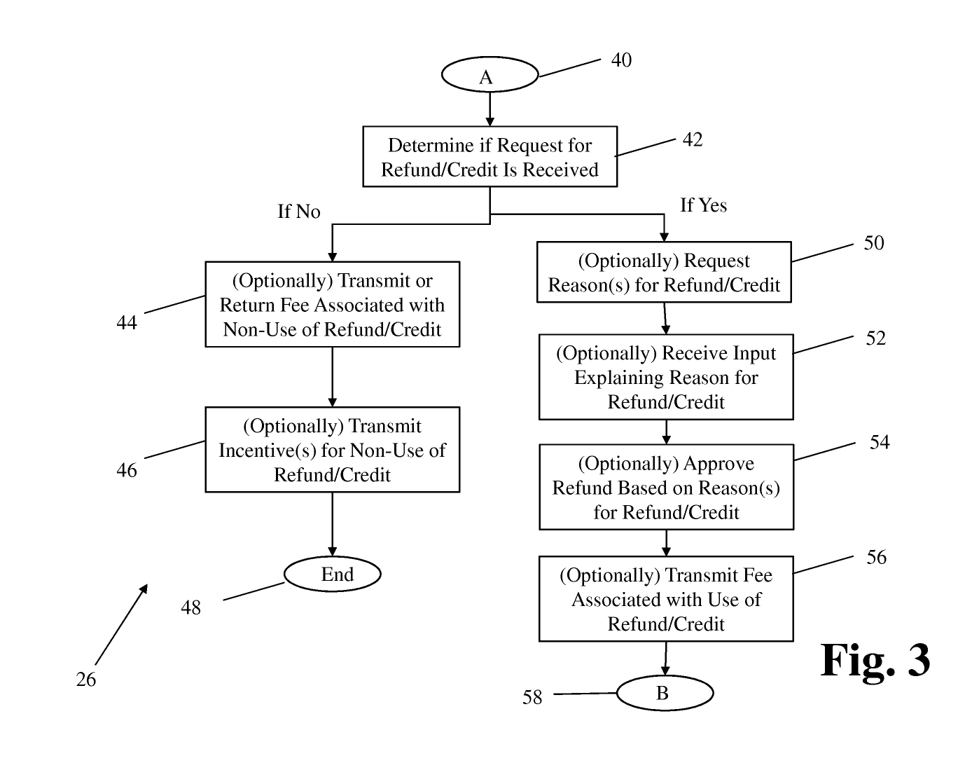

The method 26 then proceeds to step 42 via the connector 40 (labeled as “A”). The continuation of the method 26 is illustrated in FIG. 3.

At step 42, the method 26 of the present invention determines whether a request for refund/credit has been received from the user. If a request for refund/credit has been made, it is contemplated that the request will have been made via the input device 12, 14. As should be apparent, if a request for refund/credit has not been made, there is an absence of an input from the user.

So that buyer protection does not have a limitless duration, the query regarding the receipt of a request for refund/credit at step 42 may be made at a predetermined time interval (i.e., one week after the purchase of the app at step 36).

It is contemplated that the amount refunded or credited to the user may be time dependent. For example, the amount refunded or credited to the user may be a percentage of the purchase price for the purchased software, with a diminishing value over a period of time, such as a week. For example, if the method determines that a request for return/credit has been made at step 42, the user may be entitled to 100% of the purchase price (or a 100% credit) if the request was received within 2 days of purchase. If the request for return/credit is made on the third day after purchase, the user may receive 90% of the original purchase price (either as a refund or as a credit). If the refund is requested on the fourth day after purchase, the user may be entitled to 80% of the original purchase price. The price may be diminished progressively until a certain end point, such as a week, two weeks, etc.

After step 42, the method 26 may take one of two paths, as identified in FIG. 3.

If no refund or credit is ever requested, this suggests that the user was satisfied with the purchased software. As such, the method 26 proceeds to step 44. At step 44, the fee paid at either of steps 32, 34 may be transmitted to the marketplace that provided the buyer protection service according to the present invention. The marketplace may then use the fees collected from a plurality of users of the buyer protection service to offset the administrative costs of the buyer protection program, for example.

The method 26 than proceeds to step 46 where an incentive for non-use of the refund/credit is transmitted to the user. At step 46, the user might receive a complete refund of the price paid for the buyer protection. Alternatively, the user might receive a partial refund of the price paid for the buyer protection.

In still another alternative embodiment, the user may receive a credit for a future request for a refund/credit. In this embodiment, the credit may be transmitted after a predetermined number of non-uses of the purchase of the buyer protection. For example, if the user does not request a refund/credit after ten instances of payment for buyer protection, the user may receive one free credit toward a future purchase of the buyer protection of the present invention.

After step 46, the method 26 ends at step 48.

With continued reference to FIG. 3, the second branch of the method 26 after step 42 proceeds if the user has entered a request for refund/credit at step 42. Naturally, this suggests that the user is dissatisfied with the purchased software.

If the request for refund/credit is determined at step 42, the method 26 proceeds to step 50 where the user is prompted to provide a reason for the refund/credit.

At step 52, the method receives input from the user explaining the request for refund/credit. In this step, for example, the user may be presented with a list of explanations in a drop-down menu. Alternatively, the user may be presented with an input field to type in the reason for requesting the refund/credit.

After the method 26 receives input from the user explaining the reason for the request for refund at step 52, the method proceeds to step 54.

At step 54, the method 26 processes the explanation for the request for refund/credit. If the explanation satisfies predetermined criteria, the method 26 approves the refund/credit at step 54. An acceptable reason for the refund/credit may be a failure of the software to operate properly on the smart device 12, 14, for example.

The method 26 then proceeds to step 56. At step 56, the method may transmit the fee paid for the buyer protection, if the amount paid has not been previously transmitted. As should be understood, the fee is transmitted to the administrator of the marketplace. Alternatively, in the case where the buyer protection is administered by a third party, the fee is transmitted to that third party.

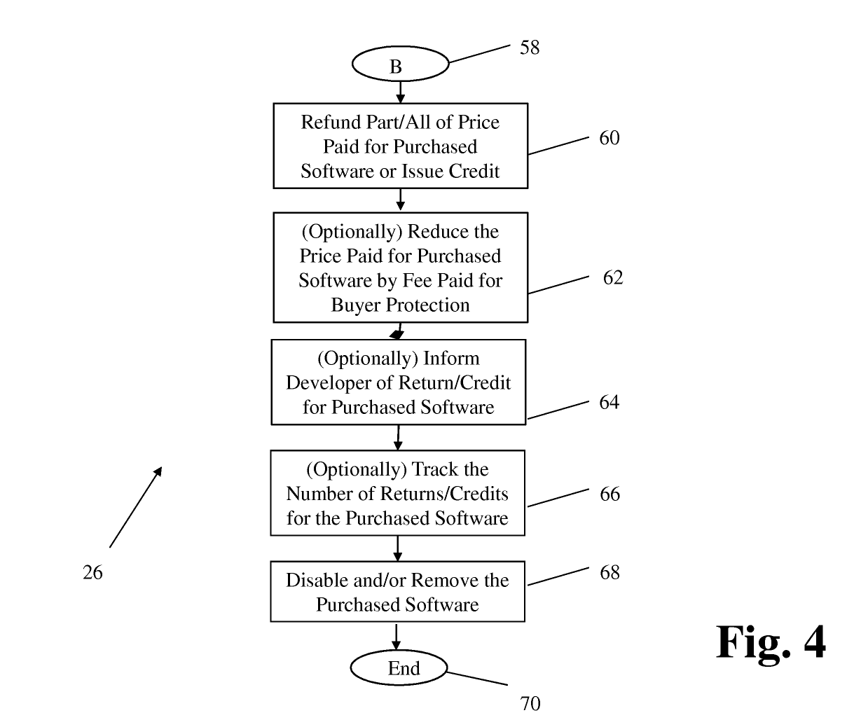

The connector 58, which is labeled “B,” connects this second branch of the method 26 to the remainder of the method 26 as illustrated in FIG. 4.

The method proceeds from step 56 to step 60 via the connector 58.

At step 60, in accordance with the buyer protection, the method 26 returns the price paid by the user or issues a credit to the user that may be applied against a future purchase of software. The refund need not be the full purchase price, as indicated above.

At step 62, the method 26 may optionally reduce the purchase price paid for the software by the fee paid for the return of the software. This option is exercised if the fee is not paid previously by the user.

Following step 62, the method 26 proceeds to step 64, where the developer of the software is informed of the return/credit of the developer's software.

At step 66, the method 26 tracks the number of refunds/credits for the software. As discussed above, this permits the marketplace or the third party administering the method 26 to assess if the software exceeds a predetermined number of requests for refund. If so, the administrator may elect to remove the software from the marketplace altogether.

At step 68, the method 26 disables the software for which a refund has been approved.

As should be appreciated, if a user downloads software that is fully functional but decides to take advantage of the refund/credit, the user will retain the fully functional software. Therefore, if the user takes advantage of the benefits of the buyer protection program, the method 26 disables the software by sending an appropriate signal to the input device 12, 14, for example. Alternatively, the method may remove the software from the user's smart device 12, 14 altogether.

As may be apparent from the foregoing, the method 26 of the present invention may be readily implemented by the administrator of a marketplace. Since the marketplace, such as the iTunes® Store, keeps track of the apps downloaded to the smart device 12, 14, the marketplace may readily remove a retuned app from the smart device 12, 14 at the time of an additional synchronization of the smart device 12, 14 with the marketplace.

In the instance where a third party administers the method 26 of the present invention, it is contemplated that a signal disabling the software may be more easily transmitted to the smart device 12, 14.

The method ends at step 70.

As should be apparent from the foregoing, the method 26 of the present invention is contemplated to be implemented via a series of graphical user interfaces (“GUIs” that are displayed on one or more devices including the input devices 12, 14. The content and arrangement of any such GUIs is not critical to the operation of the present invention.

As also should be apparent from the foregoing discussion, the order in which steps are executed by the method 26 of the present invention should not be understood to be limited to the order described herein. One or more of the operations may be executed in parallel with other operations. In addition, the operations may be performed in any of a wide variety of different orders without departing from the scope of the present invention.

Additionally, there are a number of operations that are identified as “optional” in FIGS. 2-4. These operations may or may not be implemented in one or more of the various embodiments of the present invention, as should be apparent to those skilled in the art.

As discussed above, the discussion of one or more embodiments of the present invention is not intended to be limiting thereof. To the contrary, in view of the foregoing disclosure, those skilled in the art should appreciate that there are numerous variations and equivalents that may be employed without departing from the scope of the present invention. Those variations and equivalents are intended to fall within the scope of the present invention as if described herein.

What is claimed is:

1. A method for providing buyer protection for purchased software, comprising:
from an input device, receiving input to initialize buyer protection applicable to purchased software;
providing the purchased software to the input device;
by a processor, processing payment of a fee for a return of the purchased software;
by the processor, determining that a request for return of purchased software has been received from the input device;
by the processor, approving the return of the purchased software;
by the processor, at least one of returning, as a refund, at least a portion of a price paid for the purchased software or providing a credit against a future software purchase; and
by the processor, at least one of disabling or removing the purchased software from the input device.

2. The method of claim 1, wherein the input device includes the processor.

3. The method of claim 1, wherein the fee is valid for the return of purchased software during a predetermined period of time.

4. The method of claim 1, wherein the fee is valid for a plurality of returns of purchased software during a predetermined period of time.

5. The method of claim 1, wherein the refund decreases proportionately with an increased elapsed time from a time of purchase.

6. The method of claim 1, wherein the refund is proportionate to the price paid for the purchased software.

7. The method of claim 1, further comprising:
associating the buyer protection with the purchased software.

8. The method of claim 1, further comprising:
requesting at least one reason for the return of the purchased software.

9. The method of claim 8, further comprising:
receiving input explaining the at least one reason for the return of the purchased software.

10. The method of claim 9, further comprising:
determining if the at least one reason for the return of the purchased software satisfies at least one predetermined condition for approval of the return of the purchased software.

11. The method of claim 10, further comprising:
transmitting the fee for the return of the purchased software.

12. The method of claim 1, further comprising:
reducing the price paid for the purchased software by the fee for the return of the purchased software.

13. The method of claim 1, further comprising:
informing a developer of the purchased software of the return of the purchased software.

14. The method of claim 1, further comprising:
tracking a frequency of returns for the purchased software.

15. A method for providing buyer protection for purchased software, comprising:
from an input device, receiving input to initialize buyer protection applicable to purchased software;
providing the purchased software to the input device;
by a processor, processing payment of a fee for a return of the purchased software;
by the processor, determining that a request for return of purchased software has not been received from the input device; and
by the processor, transmitting at least one incentive for non-receipt of the return of the purchased software.

16. The method of claim 15, wherein the incentive comprises at least a portion of the fee for the return of the purchased software.

17. The method of claim 16, wherein the incentive comprises the fee for the return of the purchased software.

18. The method of claim 15, wherein the incentive comprises a credit applicable against a future purchase of software.

19. The method of claim 15, wherein the at least one incentive comprises at least a portion of a price paid for the purchased software.

20. The method of claim 19, wherein the at least one incentive comprises the price paid for the purchased software.
